(19) United States
(12) Patent Application Publication
(10) Pub. No.: US 2008/0283691 A1
(43) Pub. Date: Nov. 20, 2008

(54) MONITOR STAND

(76) Inventors: Robert P. BLIVEN, Saratoga, CA (US); Jacques GAGNE, Los Gatos, CA (US); Ray GRADWOHL, Saratoga, CA (US); Kwang H. KIM, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/118,385

(22) Filed: May 9, 2008

Related U.S. Application Data
(60) Provisional application No. 60/917,018, filed on May 9, 2007.

(51) Int. Cl. F16M 11/18

(52) U.S. Cl. 248/125.2

(57) ABSTRACT

A monitor stand comprising a base, a bracket, and an arm assembly, is discussed. The arm assembly is movably coupled to the base and movably coupled to the bracket. The bracket is configured to support a monitor. The arm assembly is configured such that an action to rotate the arm assembly relative to the base is coupled and operable to proportionally rotate the bracket relative to the arm assembly.

### RELATED APPLICATIONS

This application is related to and claims priority to commonly assigned copending Provisional U.S. Patent Application No. 60/917,018, entitled “LCD Monitor Base With Height Adjust Arm assembly Using Belt And Gear Linkage,” by Bliven et al., Attorney Docket No. 200702031-1, filed May 9, 2007, which is incorporated by reference herein in its entirety.

### FIELD

Embodiments of the present invention relate in general to the field of monitor stands.

### BACKGROUND

Some adjustable monitor stands are limited in range and/or support. Additionally, some monitor stands may be inadequate for use with touch screen monitors, as the users may occasionally exert a force that may tip the monitor. Also, some monitor stands may require multiple adjustments to accommodate a desired position.

### BRIEF DESCRIPTION OF THE DRAWINGS

FIG. 1 illustrates a monitor stand upon which embodiments of the present invention may be implemented.

FIGS. 2A and 2B illustrate interior side views of an arm assembly, in accordance with embodiments.

FIG. 3 illustrates an interior front view of an arm assembly with one belt, in accordance with embodiments.

FIG. 4 illustrates an interior front view of an arm assembly with two belts, in accordance with embodiments.

FIGS. 5A and 5B illustrate interior side and front views of the base, respectively, in accordance with embodiments.

FIG. 6 illustrates an interior front view of a bracket, in accordance with embodiments.

FIGS. 7A and 7B illustrate a monitor rotation as the monitor is lowered, in accordance with the embodiments.

FIG. 8 illustrates a monitor in contact with a base, in accordance with the embodiments.

### DESCRIPTION OF EMBODIMENTS

Reference will now be made in detail to various embodiments of the present invention, examples of which are illustrated in the accompanying drawings. While the present invention will be described in conjunction with the various embodiments, it will be understood that they are not intended to limit the invention to these embodiments. On the contrary, embodiments of the present invention are intended to cover alternatives, modifications and equivalents, which may be included within the spirit and scope of the appended claims. Furthermore, in the following description of various embodiments of the present invention, numerous specific details are set forth in order to provide a thorough understanding of embodiments of the present invention. In other instances, well known methods, procedures, components, and circuits have not been described in detail as not to unnecessarily obscure aspects of the embodiments of the present invention.

Various embodiments of the present invention, a monitor stand comprising a base, a bracket, and an arm assembly, is discussed. The arm assembly is movably coupled to the base and movably coupled to the bracket. The bracket is configured to support a monitor. The arm assembly is configured such that an action to rotate the arm assembly relative to the base is coupled and operable to proportionally rotate the bracket relative to the arm assembly.

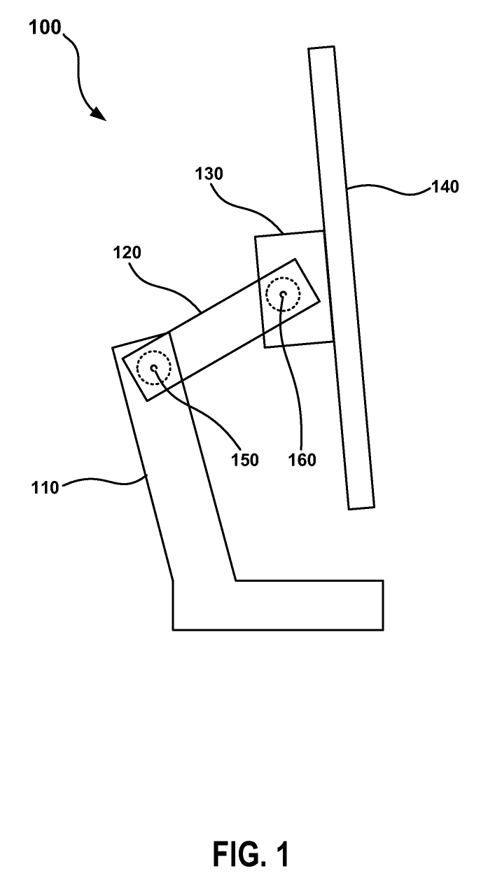

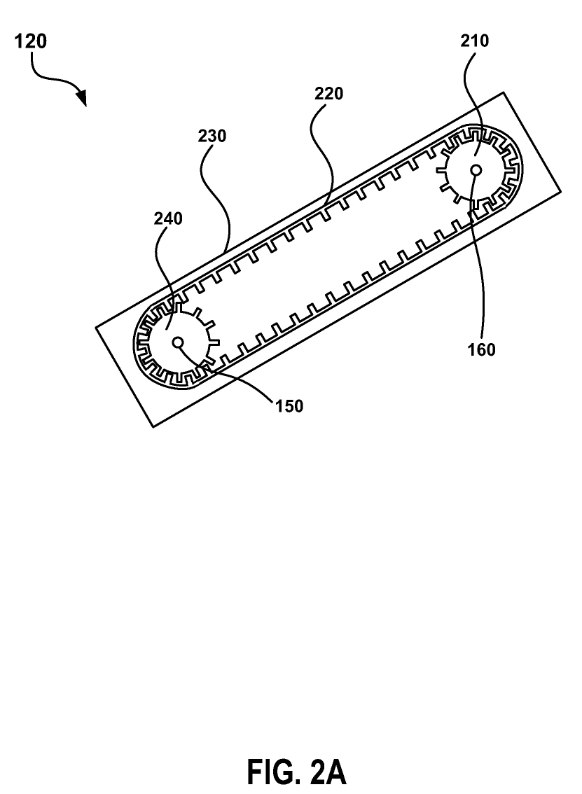

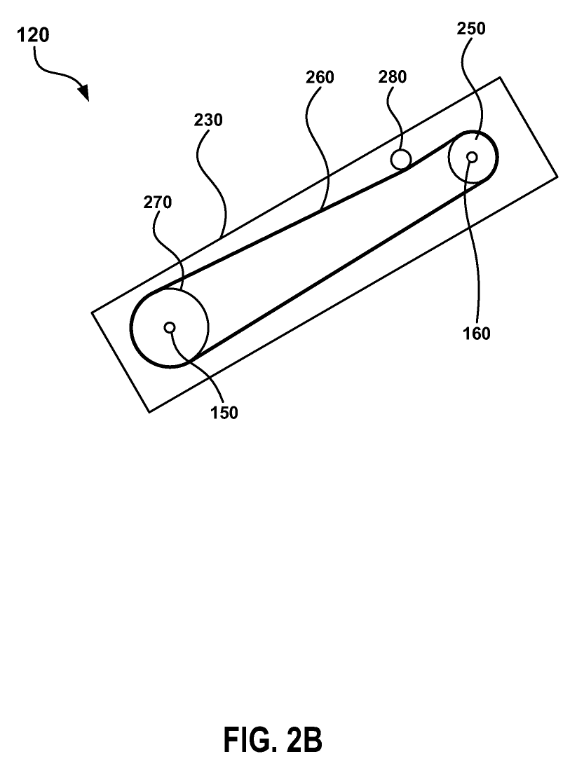

FIG. 1 illustrates a monitor stand 100 upon which embodiments of the present invention may be implemented. The monitor stand 100 comprises a base 110, an arm assembly 120, and a bracket 130. The base 110 may rest on a flat surface or be mounted on a surface, such as a wall. The arm assembly 120 comprises a base shaft 150 and a bracket shaft 160. The base shaft 150 is coupled to the base 110. The bracket shaft 160 is coupled to the bracket 130. The base shaft 150 is discussed further with regard to FIGS. 2A-5B and herein. The bracket shaft 160 is discussed further with regard to FIGS. 2A-4 and 6 and herein.

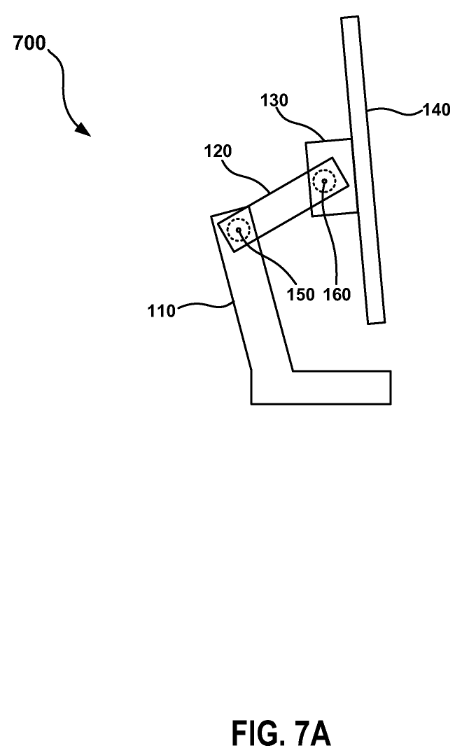

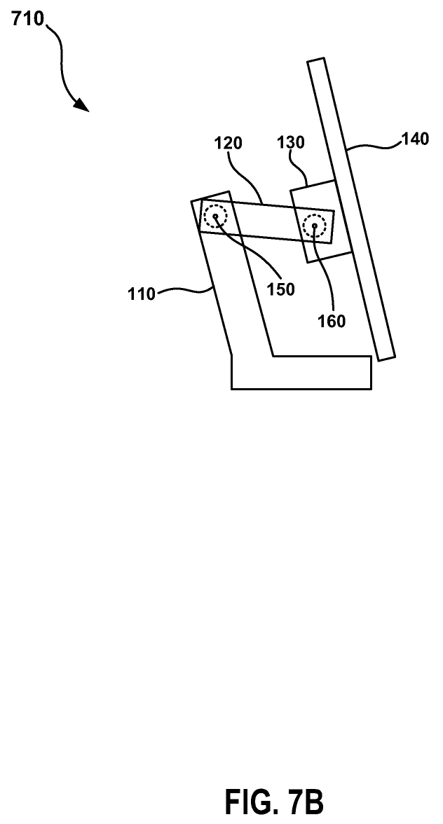

The monitor stand 100 may present a monitor 140 at a desired tilt for a range of heights. In some embodiments, the tilt remains constant as the monitor 140 is raised and lowered. In other embodiments, the monitor 140 rotates relative to the arm assembly 120 as the monitor 140 is raised and lowered. A rotating tilt may be dependent on a difference is gear diameters. Rotating tilt is discussed further with regard to FIGS. 2A, 2B and 7 and herein.

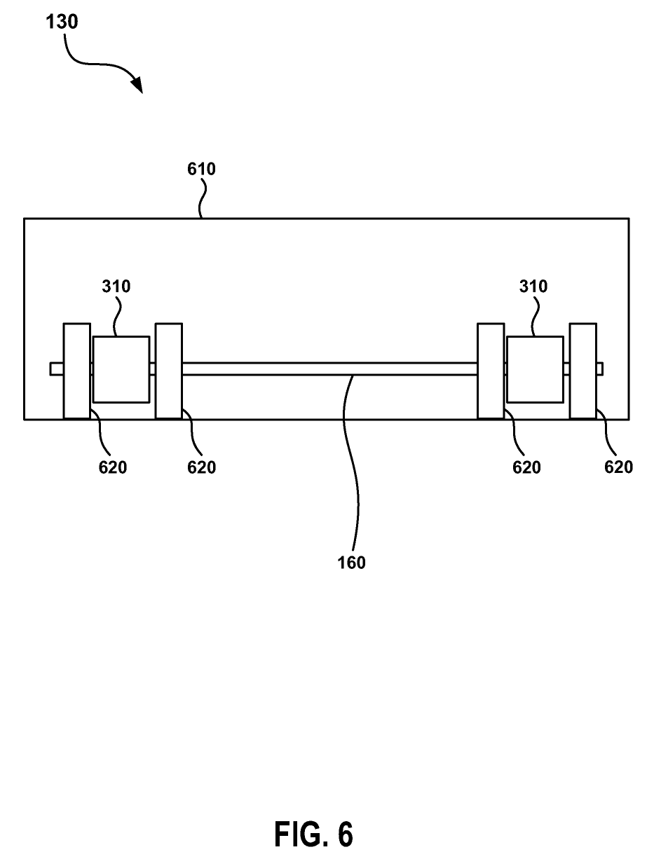

The bracket 130 may support the monitor 140. In various embodiments, the bracket 130 may support a monitor with a Video Electronics Standards Association mount. In other embodiments, the bracket 130 supports standard and/or non-standard monitor mounts. It should be appreciated the monitor 140 may be mounted to the bracket 130 in other ways, and is not limited to the described embodiments. The bracket 130 supports manual monitor tilt adjustments independent of the monitor position. The manual monitor tilt adjustments are discussed further with regard to FIG. 6 and herein.

FIGS. 2A and 2B illustrate side views of an arm assembly 120, in accordance with embodiments. In various embodiments, the arm assembly 120 in FIG. 2A comprises a gear 210, a toothed belt 220, a casing 230, and a gear 240. The gears 210 and 240 are used to synchronize the bracket shaft 160 and the base shaft 150 to obtain a desired monitor tilt as the monitor 140 is raised and/or lowered. The gears 210 and 240 and toothed belt 220 may be notched, toothed, and the like. It should be appreciated the gears 210 and 240 have other ways to synchronize the bracket shaft 160 and the base shaft 150, and is not limited to the described embodiments. The gears 210 and 240 are fixed to the bracket shaft 160 and the base shaft 150, respectively. The casing 230 may help support the shafts. In various embodiments, the toothed belt 220 may be partially toothed and partially smooth or the like.

In other embodiments, the arm assembly 120 in FIG. 2B comprises a wheel 250, a friction belt 260, a wheel 270, and a belt tensioner 280. The wheels 250 and 270 and the friction belt 260 are used to synchronize the bracket shaft 160 and the base shaft 150. The diameter of the wheel 250 is smaller than the diameter of the wheel 270 and may cause the monitor 140 to tilt forward as the monitor is raised. Monitor tilt is discussed further with regard to FIGS. 7A and 7B and herein. The optional belt tensioner 280 may be used to apply tension on the friction belt 260.

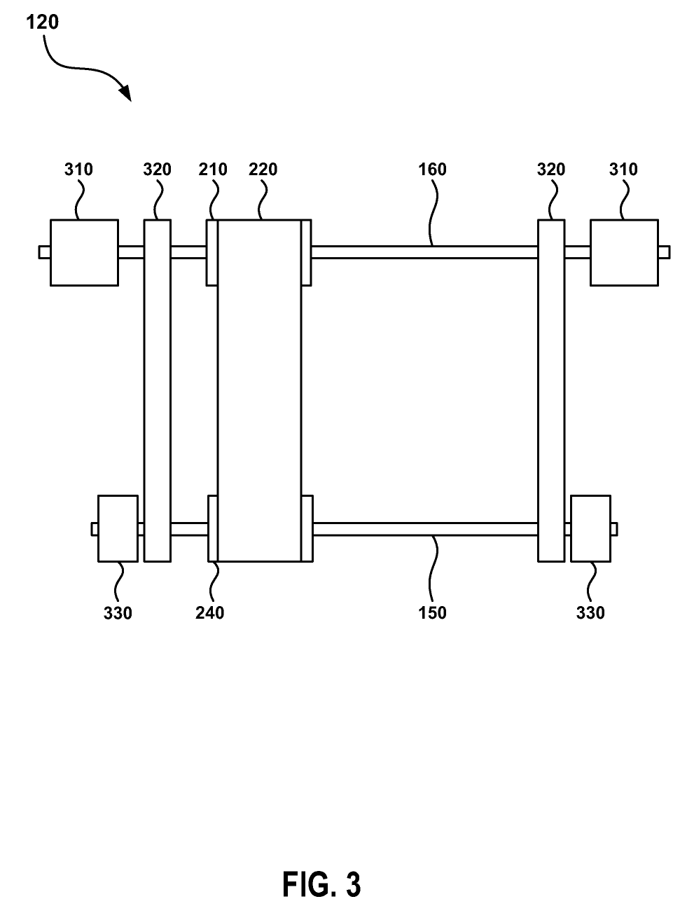

FIG. 3 illustrates an interior front view of the arm assembly 120 with one belt, in accordance with embodiments. In various embodiments, the arm assembly 120 comprises one or more supports 320. The support 320 may be used to support the arm assembly and/or to keep the toothed belt 220 in tension. As the monitor is raised or lowered, the toothed belt 220 rotates around the gears 210 and 240. The gears 210 and 240 have a similar radial velocity as the bracket shaft 160 and base shaft 150, respectively.

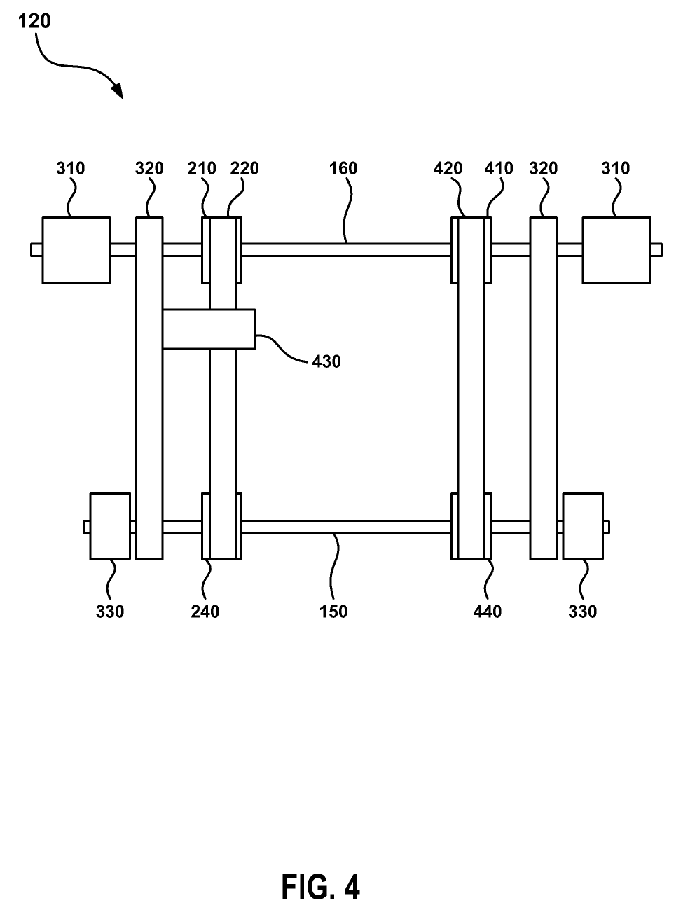

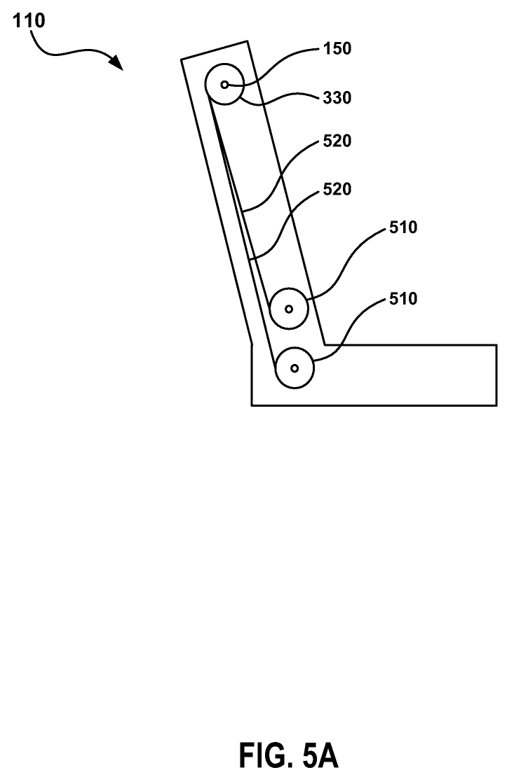

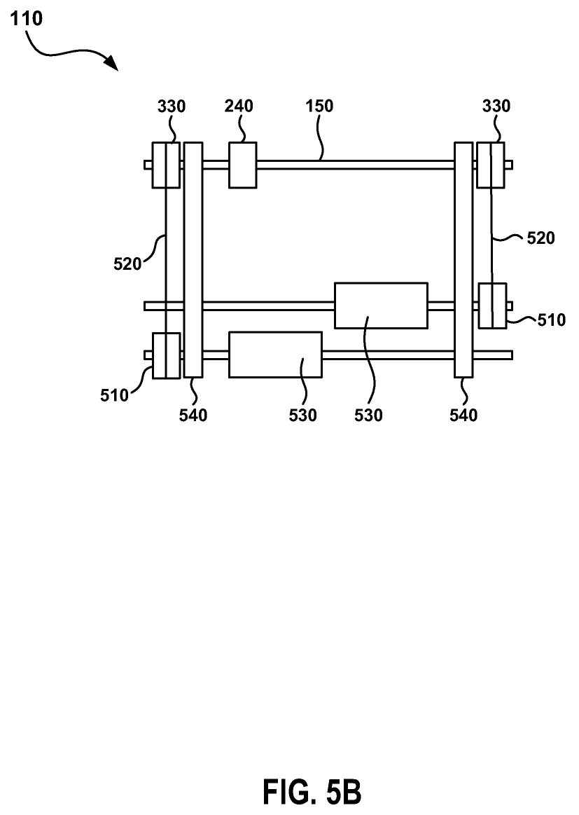

As illustrated, the arm assembly 120 has one belt. In other embodiments, the arm assembly 120 has two or more belts, as discussed further with regard to FIG. 4 and herein. Also shown in FIG. 3 are a tilt balance spring 310 and a cam pulley top 330. The tilt balance spring 310 is discussed further with regard to FIG. 6 and herein. The cam pulley top 330 is discussed further with regard to FIGS. 5A and 5B and herein.

FIG. 4 illustrates an interior front view of an arm assembly 120 with two belts, in accordance with embodiments. In various embodiments, the arm assembly 120 comprises a gear 410, a belt 420, a belt guide 430, and a gear 440. Typically, the belt 420 and the toothed belt 220 are of a similar traction, that is, they both have similar traction mechanisms, such as toothed or friction. Typically, with multiple belts, some belts are near ends of the shafts as to provide better support. The belt guide 430 guides the toothed belt 220 to prevent the toothed belt 220 from slipping off the gears 210 and 240.

FIGS. 5A and 5B illustrate interior side and front views of the base 110, respectively, in accordance with embodiments. The base 110 comprises two cam pulley tops 330, two cam pulley bottoms 510, two cables 520, two lower torsion springs 530, and supports 540. The two lower torsion springs 530 apply a torsion force at the two cam pulley bottoms 510. The force is transferred to the two cam pulley tops 330 via the two cables 520, which in turn puts a force on the gear 240 to support some or all of a weight of the monitor 140 by providing an upward lifting force near the bracket 130. The two lower torsion springs 530 may be modified with spring constants to offset the monitor weight. In various embodiments, the base 110 may have one cam and belt set, not depicted.

FIG. 6 illustrates an interior front view of a bracket 130, in accordance with embodiments. The bracket 130 comprises two tilt balance springs 310, a mount 610, and supports 620. The supports 620 couple the bracket shaft 160 with the bracket 130. The bracket shaft 160 is free to rotate through the supports 620. As the bracket shaft 160 rotates in relation to the supports 620, the two tilt balance springs 310 provide balancing forces to position the monitor 140 at a desired angle.

In various embodiments, the two tilt balance springs 310 provide holding forces to maintain the bracket 130 and the bracket shaft 160 at a constant tilt, thus maintaining the monitor 140 in a static position. The holding forces may be frictional and/or spring forces. In various embodiments, the monitor tilt may be adjusted manually by overcoming the holding forces by exerting a force and/or torque on the monitor 140. As the tilt balance springs 310 may act independently of a monitor height, the monitor 140 may be positioned at a desired height and tilt for different users.

FIGS. 7A and 7B illustrate a monitor rotation as the monitor is lowered, in accordance with the embodiments. In FIG. 7A the monitor 140 is in a position that is near perpendicular to a horizontal plane. In various embodiments, as the monitor 140 is lowered, as shown in FIG. 7B, the monitor 140 is also tilted back, that is, a top portion of the monitor, as a user is facing the monitor, is tilted back. As the bracket 130 is fixed to the monitor 140, the bracket 130 and the monitor 140 raise, lower, and rotate similar amounts.

In various embodiments, the wheels are cylindrical, or have a circular circumference, thereby producing a bracket rotation proportional to an arm assembly stroke. That is, an arm assembly stroke that is four inches will rotate the bracket 130 twice as much as an arm assembly stroke that is two inches. In other embodiments, the wheels have an oval circumference, thereby producing a bracket rotation that is dependent on an arm assembly stroke and an arm assembly position. For example, an oval shaped wheel may produce a gear ratio of 2 near a beginning of an arm assembly stroke and gradually reduce the gear ratio to 1 near an end of an arm assembly stroke, thereby generating more tilt in beginning of the arm assembly stroke and less tilt near the end of the arm assembly stroke. For both oral and circular circumferences, the ratio of diameters is proportional to the amount of rotation of the bracket 130 relative to the arm assembly 120 as the arm assembly 120 rotates relative to the base 110.

Monitor tilting as the monitor 140 is raised and lowered allows a user to make monitor height adjustments and monitor tilt adjustments with a single force. Additionally, a more horizontal monitor tilt may provide more stability for a touch screen than a touch screen in a vertical position. The more the monitor is tilted, the greater a vertical force component and the lesser a horizontal force component may be received from the touching force. The lesser the horizontal force component, the less likely that the monitor 140 may fall over.

The amount of tilt may be dependent on a diameter ratio of the gears and/or wheels. For example, if the diameter ratio of the wheels 270 and 250 is two, and the base shaft 150 rotates ten degrees for an arm assembly stroke, then the bracket shaft 160 and the monitor tilt rotate twenty degrees. In various embodiments, the monitor tilt changes ninety degrees from a full up position to a full down position. In other embodiments, where a diameter ratio is one, the monitor tilt remains constant as during upward and downward motions.

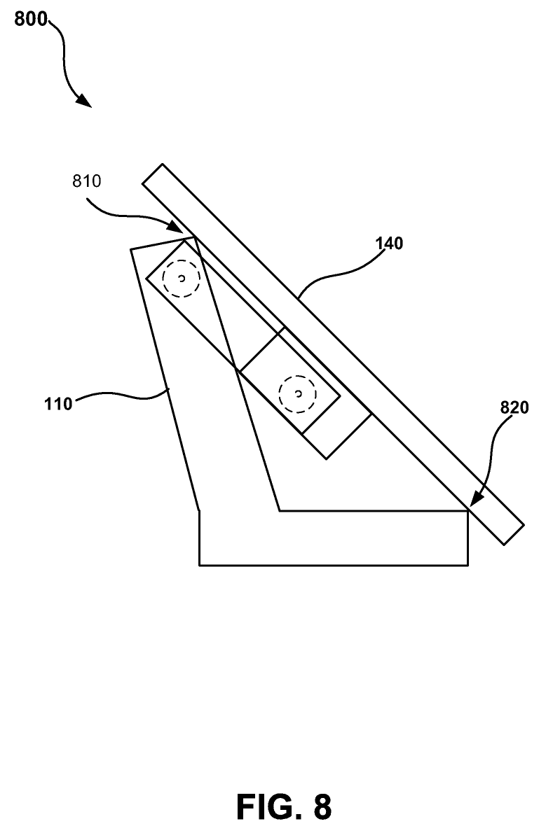

FIG. 8 illustrates a monitor 140 in contact with a base 110, in accordance with the embodiments. In various embodiments, the monitor 140 may be positioned to contact the base 110 for additional support. Some contact locations may include an upper area of the monitor 140 and near a top of the base 110, such as location 810 and/or a lower area of the monitor 140 and near a foot of the base 100, such as location 820. Contact locations may be padded, interlocking, and the like, to provide additional support and/or cushioning. The additional support provides stability for monitors that may experience unstable conditions, such as when forces are directly applied to LCD panels and/or touch screens.

Various alternatives, modifications, and equivalents may also be used. For example, the gear or wheel may be triangularly shaped as to provide more and/or less tilting at different at different arm assembly strokes, such as more tilting near a beginning and an end of the arm assembly stroke and less tilting in the middle of the arm assembly stroke. Therefore, the above description should not be taken as limiting the scope of the invention which is defined by the appended claims.

While the invention is described in conjunction with various embodiments, it is understood that they are not intended to limit the invention to these embodiments. On the contrary, the invention is intended to cover alternatives, modifications and equivalents, which may be included within the spirit and scope of the invention as defined by the appended claims.

What is claimed is:

1. A monitor stand comprising:
a base;
a bracket for supporting a monitor; and
an arm assembly movably coupled to the base and movably coupled to the bracket, wherein the arm assembly is configured such that an action to rotate the arm assembly relative to the base is coupled and operable to proportionally rotate the bracket relative to the arm assembly.

2. The monitor stand of claim 1, wherein the monitor stand is configured to rotate a front top of the monitor toward a user as the monitor is raised and to rotate the front top of the monitor away from the user as the monitor is lowered.

3. The monitor stand of claim 1, wherein an amount of bracket rotation relative to the base is greater than zero degrees and less than twenty degrees for an arm assembly stroke.

4. The monitor stand of claim 1, wherein the arm assembly comprises a first set of two gears and a toothed belt.

5. The monitor stand of claim 4, wherein an amount of bracket rotation is based on a gear diameter ratio.

6. The monitor stand of claim 4, wherein at least one of the gears is oval shaped, wherein the amount of bracket rotation is dependent of an arm assembly stroke and an arm assembly position.

7. The monitor stand of claim 4, further comprising a belt guide configured to guide the toothed belt.

8. The monitor stand of claim 4, further comprising a belt tensioner configured to put tension on the toothed belt.

9. The monitor stand of claim 4, wherein the arm assembly further comprises a second set of gears and a toothed belt.

10. The monitor stand of claim 9, wherein the arm assembly further comprises a first shaft and a second shaft, wherein the first set of gears and the toothed belt and the second set of gears and the toothed belt both couple the first shaft and the second shaft.

11. The monitor stand of claim 10, wherein the bracket comprises a first tilt balance spring and a second tilt balance spring,
wherein the first shaft is coupled to the first tilt balance spring and the second tilt balance spring,
wherein the first and second tilt balance springs are configured to provide holding forces to maintain the bracket and the first shaft at a constant tilt,
wherein the base comprises a first lower torsion spring, a second lower torsion spring, a first set of cams and a cable, and a second set of cams and a cable,
wherein the second shaft is coupled to the first lower torsion spring via a first set of cams and the cable, and the second shaft is coupled to the second lower torsion spring via the second set of cams and the cable,
wherein the first lower torsion spring and the second lower torsion spring are configured to provide an upward lifting force.

12. The monitor stand of claim 1, wherein the base is configured to rest on a flat surface.

13. The monitor stand of claim 1, wherein the base is configured to mount on a surface.

14. The monitor stand of claim 1, wherein the bracket is further configured for tilt adjustments independent of a bracket height position.

15. The monitor stand of claim 1, wherein the monitor is a touch screen monitor.

16. The monitor stand of claim 1, wherein the monitor has a Video Electronics Standards Association mount.

17. A monitor stand comprising:
a base;
an arm assembly movably coupled to the base, the arm assembly comprising a first set of two wheels and a belt; and
a bracket movably coupled to the arm assembly, wherein the bracket is configured to support a monitor,
wherein the monitor stand is configured to support bracket upward motion and bracket downward motion, such that an action to rotate the arm assembly relative to the base is coupled and operable to rotate the bracket relative to the arm assembly, wherein an amount of rotation is proportional to a wheel diameter ratio.

18. The monitor stand of claim 17, wherein the bracket rotation relative to the base is greater than zero degrees and less than twenty degrees for an arm assembly stroke.

19. The monitor stand of claim 17, wherein the arm assembly further comprises a second set of two wheels and a belt, wherein the first set and the second set of wheels are geared and the belts are toothed.

20. A monitor stand comprising:
a base;
an arm assembly movably coupled to the base comprising four gears and two belts; and
a bracket movably coupled to the arm assembly, wherein the bracket is configured to support a monitor and to permit tilt adjustments independent of an arm assembly position,
wherein the monitor stand is configured to support bracket upward motion and bracket downward motion, such that an action to rotate the arm assembly relative to the base is coupled and operable to rotate the bracket relative to the arm assembly,
wherein an amount of rotation is proportional to a gear diameter ratio,
wherein the monitor stand is further configured to rotate a front top of the monitor toward a user as the monitor is raised and to rotate the front top of the monitor away from the user as the monitor is lowered.
